(19) United States
(12) Patent Application Publication
(10) Pub. No.: US 2023/0166338 A1
(43) Pub. Date: Jun. 1, 2023

(54) HYDRAULIC EXPANSION CHUCK

(71) Applicant: Guehring KG, Albstadt (DE)

(72) Inventor: Klaus MATHEIS, Sauldorf/Rast (DE)

(73) Assignee: Guehring KG, Albstadt (DE)

(21) Appl. No.: 17/935,226

(22) Filed: Sep. 26, 2022

Related U.S. Application Data
(63) Continuation of application No. PCT/DE2021/100214, filed on Mar. 3, 2021.

(30) Foreign Application Priority Data
Mar. 27, 2020 (DE) 10 2020 108 559.1

(51) Int. Cl. B23B 31/30; B23B 31/00

(52) U.S. Cl. CPC B23B 31/305; B23B 31/005

(57) ABSTRACT

A hydraulic expansion chuck for accommodating a machining tool, comprising a main chuck body that has a first chuck portion for fastening to a chuck connection as well as a second chuck portion for clamping the machining tool, wherein the second chuck portion includes a substantially cylindrical cavity, and wherein at least a first chamber and a second chamber for holding a fluid are arranged within the second chuck portion in such a way as so peripherally surround at least some sections of the cavity, and said first chamber and second chamber are designed in such a way as to bulge and reduce a cross-section of the cavity in at least some sections when the pressurized fluid is admitted into the chambers, the first chamber and the second chamber being positioned at an angle to one another.

The invention relates to a hydraulic expansion chuck for accommodating a tool, in particular for a machining tool.

The use of hydraulic expansion chucks is widespread. Conventional hydraulic expansion chucks are constructed in one piece and have a portion with chambers located on the inside for clamping a tool, as well as a portion for the machine-side connection. To brace the tool, a fluid is introduced into chambers, which fill up and expand under pressure. Due to the expansion of these chambers, the tool, which is introduced into the tool chuck, is clamped. Hydraulic expansion chucks clamp a tool, when a chamber or a line bulges in the direction of the tool to be accommodated and thus exerts a clamping force on the tool shaft. An unclamping of the tool takes place by discharging the fluid.

In the prior art, a hydraulic expansion chuck for accommodating and clamping machining tools is described, for example, in DE 10 2015 120 971 A1. It comprises a main chuck body with a separate clamping bushing, on the front end of which the shaft of a machining tool is clamped. Coaxial chambers, into which a fluid is admitted under pressure in order to bulge the chambers outwards, is arranged within the wall of the front part.

The constantly coaxial alignment of the chambers to the accommodation opening and the parallel alignment of the chambers to one another, whereby the occurrence of high clamping forces is limited and the optimal clamping of a shaft of a machining tool is thus not ensured, is a disadvantage of these known hydraulic expansion chucks.

It is the object of the present invention to provide a hydraulic expansion chuck, which overcomes the disadvantages from the prior art and which is suitable to optimally clamp the shaft of a machining tool.

The invention comprises a hydraulic expansion chuck for accommodating a machining tool comprising a main chuck body with a first chuck portion for fastening to a chuck connection, and a second chuck portion for bracing the machining tool. The second chuck portion thereby comprises an essentially cylindrical cavity, and at least a first chamber and a second chamber for accommodating a fluid are arranged within the second chuck portion in order to circumferentially enclose the cavity at least in sections. The first chamber and the second chamber are formed in order to bulge during the pressurized admittance of the fluid and in order to decrease a cross section of the cavity at least in sections. The first chamber and the second chamber are thereby arranged at an angle α to one another. This allows for the adjustment of high clamping forces and thus the optimal clamping of a shaft of a machining tool into the hydraulic expansion chuck.

It is technically particularly advantageous when the first chamber and the second chamber are arranged at an angle α of between 2° and 10° to one another.

According to an advantageous aspect, the first chamber and the second chamber are directly connected to one another.

According to a further advantageous aspect, the second chamber is arranged at an angle β of between 2° and 10° to the cavity.

According to another advantageous aspect, the cavity comprises a first essentially cylindrical cavity portion with a diameter D₁ and a second essentially cylindrical cavity portion with a diameter D₂≠D₁. The first cavity portion and the second cavity portion are thereby indirectly or directly connected to one another.

According to a preferred aspect, the first cavity portion and the second cavity portion are indirectly connected to one another by means of a third portion. The third portion is thereby formed as essentially L- or S-shaped ledge.

According to a further preferred aspect, the second chamber is arranged in order to enclose the third portion.

According to a particularly preferred aspect, the hydraulic expansion chuck comprises at least one fluid inlet, which fluid inlet connects an outer side of the hydraulic expansion chuck to the first chamber and/or the second chamber.

According to an advantageous aspect, a third chamber, which is connected to the first chamber via at least one channel arranged within the second chuck portion, is arranged within the second chuck portion.

According to a further advantageous aspect, the first chamber, the second chamber, and the third chamber are arranged between 0.1 mm and 2 mm spaced apart from an outer side of the cavity.

According to a particularly advantageous aspect, the first chamber has a length L₁ and the second chamber has a length L₂. The ratio L₁:L₂ is thereby between 1:2 and 2:1.

The invention will be described in more detail below on the basis of the examples illustrated in the enclosed drawings. Identical reference numerals relate to the same features in all figures, in which:

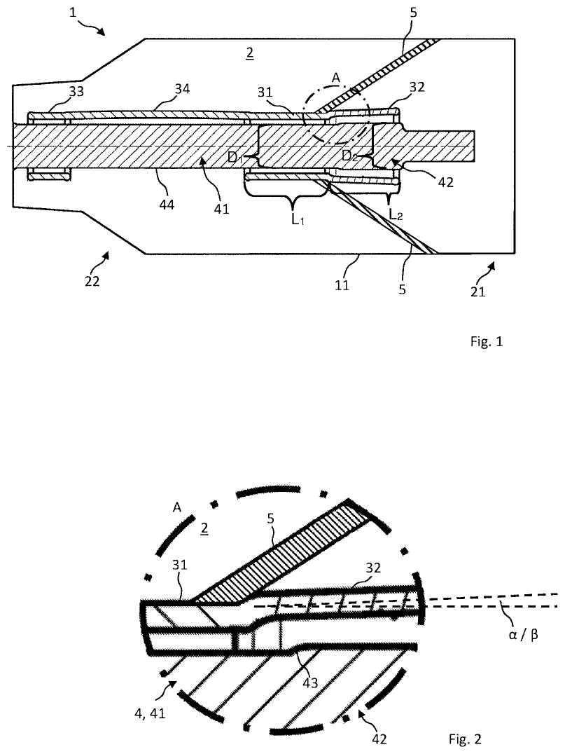

FIG. 1 shows a sectional view of the hydraulic expansion chuck; and

FIG. 2 shows a detailed view onto a part of the hydraulic expansion chuck from FIG. 1.

FIG. 1 shows a sectional view of the hydraulic expansion chuck 1 for accommodating a machining tool. The hydraulic expansion chuck 1 comprises a main chuck body 2 with a first chuck portion 21 for fastening to a chuck connection, and a second chuck portion 22 for bracing the machining tool. The second chuck portion 22 thereby comprises an essentially cylindrical cavity 4. A first chamber 31, a second chamber 32, and a third chamber 33 for accommodating a fluid are arranged within the second chuck portion 22 in order to circumferentially enclose the cavity in sections.

The first chamber 31 and the second chamber 32 are directly connected to one another. The third chamber 33 is connected to the first chamber 31 via a channel 34 arranged within the second chuck portion 22.

The chambers 31, 32, 33 are formed in order to bulge during the pressurized admittance of the fluid and in order to decrease a cross section of the cavity 4 in sections. A shaft of a machining tool introduced into the cavity can be braced thereby.

The first chamber 31 is arranged coaxially to the cavity. The second chamber 32 is arranged at an angle β (shown in FIG. 2) of 2° to the first chamber 31 and to the cavity 4.

The first chamber 31 thereby has a length L₁ and the second chamber 32 has a length L₂. The ratio L₁:L₂ is thereby between 1.2:1.

The first chamber 31, the second chamber 32, and the third chamber 33 are arranged between 0.2 mm and 0.6 mm spaced apart from an outer side 44 of the cavity 4. While the first chamber 31 and the third chamber 33 have a constant distance from the outer side 44, the second chamber has an increasing distance from the outer side 44, which results from the angled arrangement of the second chamber 32 relative to the cavity 4.

The first cylindrical cavity portion 4 has a diameter D₁ and a second cylindrical cavity portion 42 has a diameter D₂>D₁. The first cavity portion 41 and the second cavity portion 41 are connected to one another by means of a third portion 43 (shown in FIG. 2).

The third portion 43 (shown in FIG. 2) is thereby formed as essentially L-shaped ledge with rounded corner.

The hydraulic expansion chuck 1 comprises two fluid inlets 5. The fluid inlets 5 in each case connect an outer side 11 of the hydraulic expansion chuck 1 to the first chamber 31.

FIG. 2 shows a detailed view A onto a part of the hydraulic expansion chuck from FIG. 1.

The first cavity portion 41 and the second cavity portion 42 are connected to one another by means of a third portion 43. The first chamber 31 is thereby arranged coaxially to the cavity 4. The second chamber 32 is arranged at an angle α=2° to the first chamber 31 and to the cavity 4. In the shown example, the angle α corresponds to the angle β. The second chamber 32 is arranged in order to enclose the third portion 43. The third portion 43 is thereby formed as essentially L-shaped ledge with rounded corner.

If the third chamber 43 bulges due to the pressurized admittance of the fluid, the ledge is moved in the direction of the cavity 4 and thus decreases the cross section thereof. If, for example, the shaft of a machining tool is introduced into the cavity 4, a particularly high clamping pressure, which optimally clamps the shaft, occurs, inter alia, at that point, at which the third portion 43 clamps the shaft.

1. A hydraulic expansion chuck for accommodating a machining tool comprising a main chuck body with a first chuck portion for fastening to a chuck connection, and a second chuck portion for bracing the machining tool, wherein the second chuck portion comprises an essentially cylindrical cavity, and wherein at least a first chamber and a second chamber for accommodating a fluid are arranged within the second chuck portion in order to circumferentially enclose the cavity at least in sections, and which the first chamber and the second chamber are formed in order to bulge during the pressurized admittance of the fluid and in order to decrease a cross section of the cavity at least in sections, and wherein the first chamber and the second chamber are arranged at an angle (α) to one another.

2. The hydraulic expansion chuck according to claim 1, wherein the angle (α) is between 2° and 10°.

3. The hydraulic expansion chuck according to claim 1, wherein the first chamber and the second chamber are directly connected to one another.

4. The hydraulic expansion chuck according to claim 1, wherein the second chamber is arranged at an angle (β) of between 2° and 10° to the cavity.

5. The hydraulic expansion chuck according to claim 1, wherein the cavity comprises a first essentially cylindrical cavity portion with a diameter D₁ and a second essentially cylindrical cavity portion with a diameter D₂≠D₁, and wherein the first cavity portion and the second cavity portion are indirectly or directly connected to one another.

6. The hydraulic expansion chuck according to claim 5, wherein the first cavity portion and the second cavity portion are indirectly connected to one another by a third portion, wherein the third portion is formed as essentially an L- or S-shaped ledge.

7. The hydraulic expansion chuck according to claim 6, wherein the second chamber is arranged in order to enclose the third portion.

8. The hydraulic expansion chuck according to claim 1, comprising at least one fluid inlet, which fluid inlet connects an outer side of the hydraulic expansion chuck to the first chamber and/or the second chamber.

9. The hydraulic expansion chuck according to claim 1, wherein a third chamber, which is connected to the first chamber via at least one channel arranged within the second chuck portion, is arranged within the second chuck portion.

10. The hydraulic expansion chuck according to claim 9, wherein the first chamber, the second chamber, and the third chamber are arranged between 0.1 mm and 2 mm spaced apart from an outer side of the cavity.

11. The hydraulic expansion chuck according to claim 1, wherein the first chamber has a length L₁ and the second chamber has a length L₂, wherein the ratio L₁:L₂ is between 1:2 and 2:1.
